(19) United States
(12) Patent Application Publication
(10) Pub. No.: US 2004/0214599 A1
(43) Pub. Date: Oct. 28, 2004

(54) Wireless communications system for software downloading

(76) Inventor: Hiroyasu Ogino, Toyoake-city (JP)

Correspondence Address: HARNESS, DICKEY & PIERCE, P.L.C., P.O. BOX 828, BLOOMFIELD HILLS, MI, 48303, US

(21) Appl. No.: 10/829,102

(22) Filed: Apr. 21, 2004

(30) Foreign Application Priority Data
Apr. 23, 2003 (JP) 2003-118608

(51) Int. Cl. H04M 3/00; H04M 1/00; H04B 1/38

(52) U.S. Cl. 455/556.1; 455/557; 455/419

(57) ABSTRACT

An in-vehicle communications terminal starts a software downloading via a wireless communications line from a center communications terminal when an accessory switch of a vehicle is being turned off. Thus, the software is downloaded when a user is not in a vehicle or when a user does not drive the vehicle even while the user exists in the vehicle. This avoids the problem deriving from occupying the wireless communications line, enabling the capability of the resource to be sufficiently used for the software downloading.

### CROSS REFERENCE TO RELATED APPLICATIONS

This application is based on and incorporates herein by reference Japanese Patent Application No. 2003-118608 filed on Apr. 23, 2003.

### FIELD OF THE INVENTION

The present invention relates to a communications system where a software is downloaded via a wireless communications network from a center communications terminal to an in-vehicle communications terminal, further relating to the individual center communications terminal and the in-vehicle communications terminal.

### BACKGROUND OF THE INVENTION

Conventionally, a software for an in-vehicle communications terminal or other in-vehicle devices is downloaded via a wireless communications network from a center communications terminal to the in-vehicle communications terminal to be simply updated (refer to JP-A-H11-27749).

Here, once a center communications terminal starts to download a software to an in-vehicle communications terminal, a communications line is occupied by this downloading. Other processes are thereby prevented from using this communications line, causing a problem. Other processes include a reception of map data from a map data distribution service, and a reception of available data from a web site.

Further, since the in-vehicle communications terminal parallelly uses its resource for both the downloading and other processes, the resource cannot be sufficiently used for the downloading. This involves problems such as a prolonged downloading period, an increased communications cost, and unnecessary occupation of the communications line.

### SUMMARY OF THE INVENTION

It is an object of the present invention to provide a wireless communications system where an in-vehicle communications terminal can adequately start a software downloading from a center communications terminal.

To achieve the above object, a wireless communications system between a center and a vehicle for a downloading of a software is provided with the following. A center communications terminal is provided in the center for downloading the software, while an in-vehicle communications terminal is provided in the vehicle for receiving the downloaded software from the center communications terminal. Here, when it is assumed that the vehicle is not driven, the in-vehicle communications terminal is permitted to start the software downloading from the center communications terminal.

For instance, when the accessory switch is being turned off, a user is not in the vehicle or the user does not drive the vehicle even when the user is in the vehicle. Namely, while the vehicle is not driven, the downloading of the software is executed from the center communications terminal to the in-vehicle communications terminal. Occupying the communications line for the downloading does not influence any other communications processes. This enables the resource to be sufficiently used for the downloading, resulting in efficient performing of the software downloading.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram showing a schematic structure of a wireless communications system according to an embodiment of the present invention;

FIG. 2 is a flowchart diagram explaining process when a center communications terminal starts a software downloading (DL) according to the embodiment;

FIG. 3 is a flowchart diagram explaining process when an in-vehicle communications terminal starts a software downloading (DL) according to the embodiment; and

FIGS. 4, 5 are diagrams showing sequences up to a start of a software downloading (DL) according to the embodiment;

FIG. 6 is a flowchart diagram explaining process when a center communications terminal resumes a software downloading (DL) according to the embodiment;

FIG. 7 is a flowchart diagram explaining process when an in-vehicle communications terminal resumes a software downloading (DL) according to the embodiment; and

FIGS. 8 to 11 are diagrams showing sequences up to a resumption of a software downloading (DL) according to the embodiment.

### DETAILED DESCRIPTION OF THE PREFERRED EMBODIMENTS

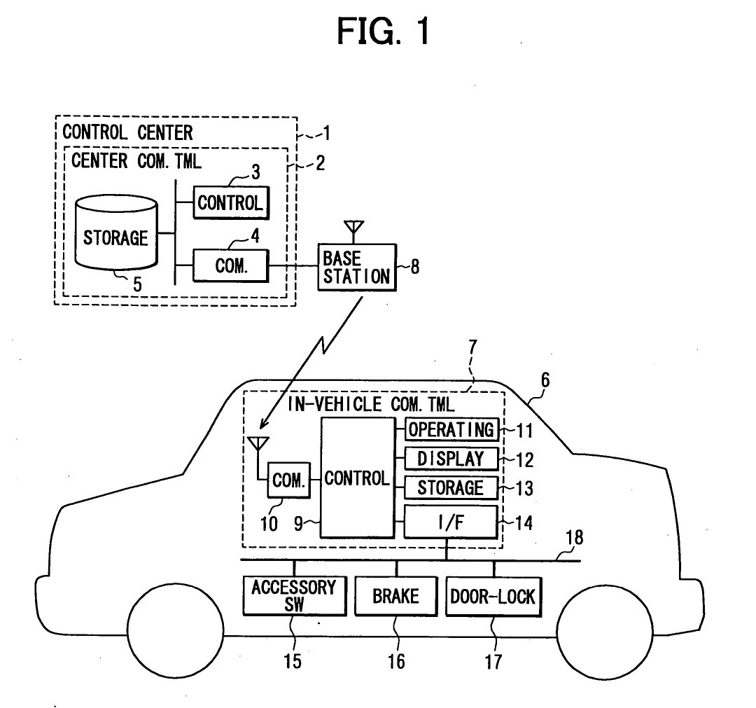

The present invention is directed to a wireless communications system as an embodiment shown in FIG. 1. Here, a control center 1 includes a center communications terminal (TML) 2 that has a control unit 3, a communications unit 4, and a software storage 5. The control unit 3 is constructed of a CPU, a RAM, a ROM, etc., for controlling the overall operation of the center communications terminal 2 by executing a control software.

The software storage 5 stores software programs (hereinafter “software”) for an in-vehicle communications terminal 7 and other devices mounted in a vehicle 6. The communications unit 4 sends (or downloads) via a wireless base station 8 to the in-vehicle communications terminal 7 a software stored in the software storage 5. Here, the software includes a control software for controlling the overall operation of the in-vehicle communications terminal 7 and other in-vehicle devices, and an application software executable by the in-vehicle communications terminal 7 and other in-vehicle devices.

The in-vehicle communications terminal (TML) 7 includes a control unit 9, a wireless communications unit 10, an operating unit 11, a displaying unit 12, a storage 13, an in-vehicle LAN interface (I/F) 14. The control unit 9 is constructed of a CPU, a RAM, a ROM for controlling an overall operation of the in-vehicle communications terminal 7. The wireless communications unit 10 receives a software downloaded by the center communications terminal 2.

The operating unit 11 is constructed of, e.g., mechanically installed keys or bottoms, or touch-panel type keys or bottoms shown in the displaying unit 12. The displaying unit 12 is, e.g., a liquid crystal display to display a window pertinent to an inputted instruction. The storage 13 stores information such as a control software executed by the control unit 9.

The in-vehicle LAN interface 14 is connected via an in-vehicle LAN 18 with an accessory switch 15, a parking brake 16, a door-lock mechanism 17, and others. The in-vehicle LAN interface 14 receives an ON or OFF signal from the accessory switch 15 to detect whether the accessory switch 15 is turned on or off; an ON or OFF signal from the parking brake 16 to detect whether the parking brake 16 is turned on or off; and an lock or unlock signal from the door-lock mechanism 17 to detect whether the door is locked or unlocked. The in-vehicle communications terminal 7 that has the above structure can be partially or entirely constituted by a known car navigation system.

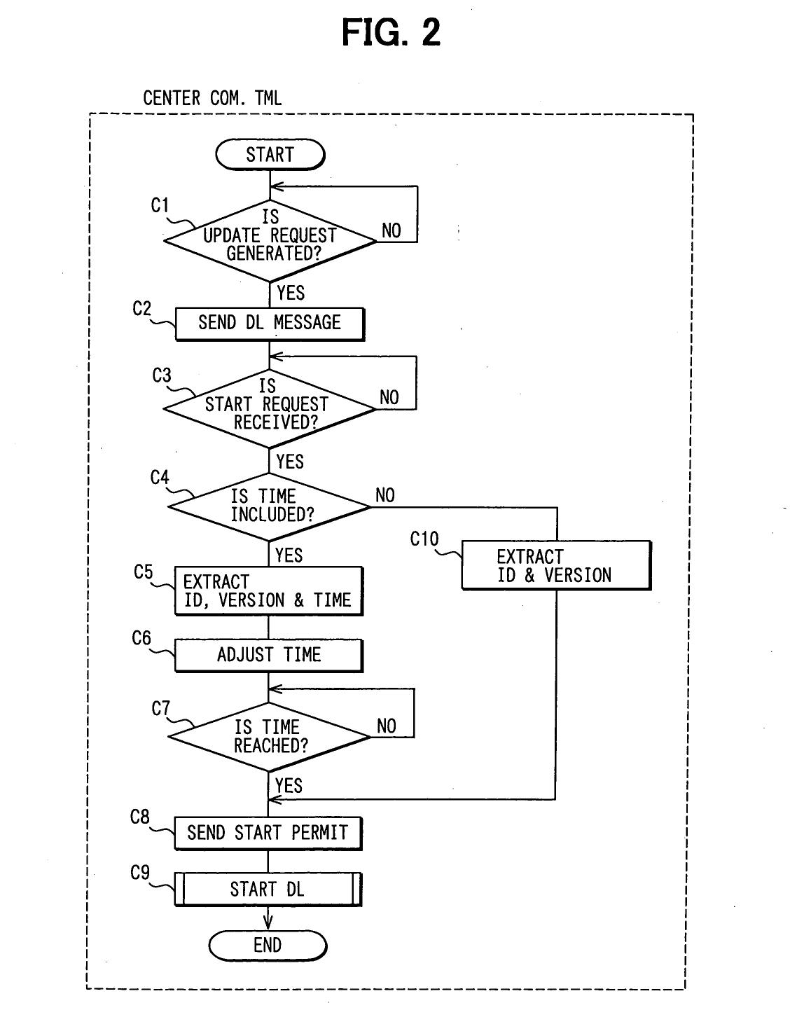

A function of the above-mentioned structure will be explained with referring to FIGS. 2 to 11. In the first place, it is supposed that the in-vehicle communications terminal 7 starts a software downloading (referred to as “DL” in the figures) from the center communications terminal 2, which means that the in-vehicle communications terminal 7 starts to receive a software downloaded from the center communications terminal 2. By contrast, that the center communications terminal 2 starts a software downloading to the in-vehicle communications terminal 7 means that the center communications terminal 2 starts to download a software to the in-vehicle communications terminal 7. Here, the following two processes will be explained.

(1) Starting process when the in-vehicle communications terminal 7 starts a software downloading from the center communications terminal 2

(2) Resuming process when the in-vehicle communications terminal 7 resumes, after once stopping or interrupting, a software downloading from the center communications terminal 2

The two processes will be explained in order.

(1) Starting Process (refer to FIGS. 2 to 5)

Referring to FIG. 2, with respect to the center communications terminal 2, at Step C1, the control unit 3 detects whether an update request for updating a software of the in-vehicle communications terminal 7 is generated or not. At Step C2, the control unit 3 generates a download message signal to send it to the in-vehicle communications terminal 7 using the communications unit 4 via the wireless base station 8, when the update request is detected to be generated (YES at Step C1). This download message signal includes a version of the software, an importance level for the software, and a file size of the software.

Here, the download massage signal is sent as notice information or an e-mail (electronic mail) to the in-vehicle communications terminal 7. The importance level indicates a numerical level of a bug or an influence. Namely, when a level of a bug or influence is so high that a quick countermeasure is required, the level becomes relatively high. By contrast, when a level of a bug or influence is so low that no quick countermeasure is required, the level becomes relatively low.

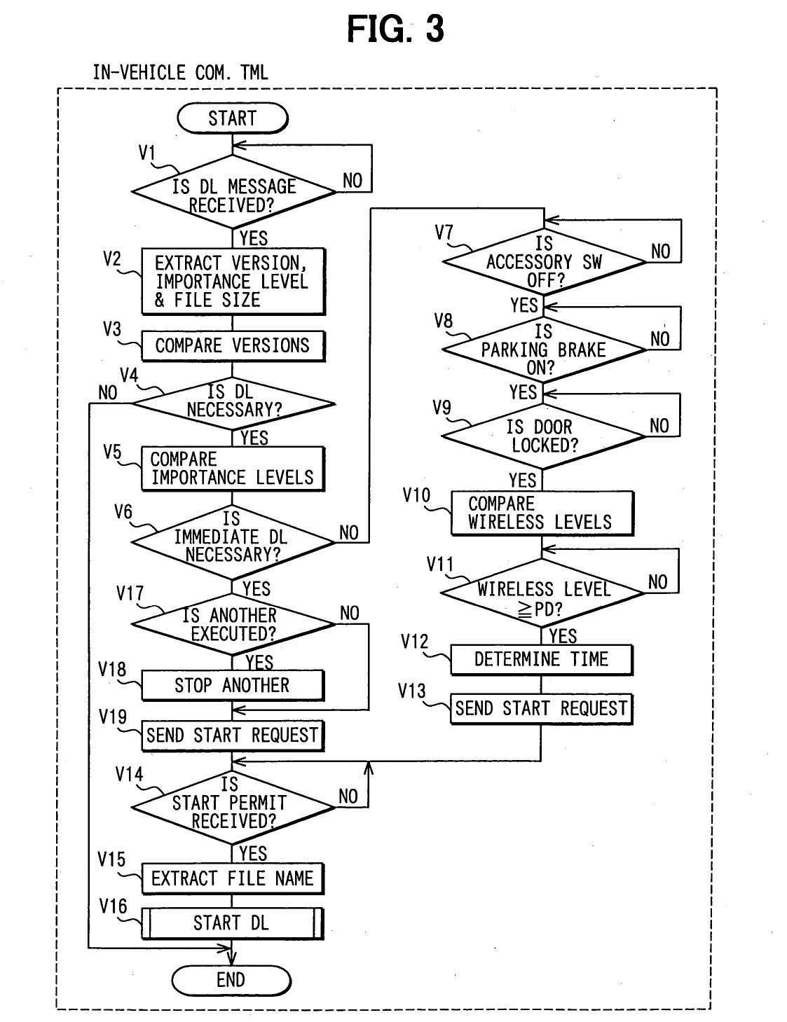

Referring to FIG. 3, in the in-vehicle communications terminal 7, when the control unit 9 detects that the wireless communications unit 10 receives the download message signal sent by the center communications terminal 2 (YES at Step V1), the control unit 9 extracts the software version, the importance level, and the file size from the download message signal at Step V2. The control unit 9 compares the software version in the download massage signal with that of the software currently possessed at Step V3 to determine whether the downloading of the software is necessary at Step V4.

When the software version in the download message signal is newer than that of the software currently possessed, the downloading is determined to be necessary (YES at Step V4). Further, the control unit 9 compares the importance level in the download massage signal with a predetermined importance level at Step V5 to determine whether the immediate downloading of the software is necessary at Step V6. Here, the predetermined importance level can be uniformly set in common for the multiple in-vehicle communications terminals 7 by the center communications terminal 2 or individually set by each of the multiple in-vehicle communications terminals 7.

When the importance level in the download message signal is less than the predetermined level, the immediate downloading is determined to be unnecessary (NO at Step V6). Further, the control unit 9 detects whether the accessory switch 15 is being turned off at Step V7, whether the parking brake 16 is being turned on at Step V8, and then whether the door-lock is opened, closed, and locked at Step V9.

When the control unit 9 detects that the accessory switch 15 is being turned off (YES at Step V7), that the parking brake 16 is being turned on (YES at Step V8), and then that the door-lock is opened, closed, and locked (YES at Step V9), the control unit 9 compares the wireless communications environment level between the in-vehicle communications terminal 7 and center communications terminal 2 with a previously predetermined wireless communications environment level at Step V10. Here, the wireless communications level includes a reception electric field strength level or an interference potential level of the in-vehicle communications terminal 7. Here, the predetermined wireless communications environment level can be uniformly set in common for the multiple in-vehicle communications terminals 7 by the center communications terminal 2 or individually set by each of the multiple in-vehicle communications terminals 7.

When the wireless communications environment level is determined to be equal or more than the predetermined (PD) level (YES at Step V11), the control unit 9 performs as follows: to determine a time of day for starting the software downloading from the center communications terminal 2 (Step V12); to generate a download start request based on an terminal ID uniquely assigned to the in-vehicle communications terminal 7 (e.g., based on an end number of the terminal ID) as identification information; and to cause the wireless communications unit 10 to send out the download start request to the center communications terminal 2 (Step V13). The download start request signal includes the time of day for starting the software downloading, the terminal ID, and the version of the currently possessed software.

Then, in the center communications terminal 2, when the control unit 3 detects that the communications unit 4 receives the download start request signal sent by the in-vehicle communications terminal 7 (YES at Step C3), the control unit 3 determines whether the time of day for starting the software downloading is included in the download start request signal at Step C4. When the time of day for starting the software downloading is determined to be included (YES at Step C4), the time of day for starting the software downloading, the terminal ID, and the software version are extracted at Step C5.

Next, the control unit 3 adjusts the time of day for starting the software downloading at Step C6. Namely, when the control unit 3 receives multiple download start requests from the multiple in-vehicle communications terminals 7, the control unit 3 intentionally varies the respective times of day for the multiple in-vehicle communications terminals 7. This can prevent concentrated generation of many loads due to simultaneous downloading to the multiple in-vehicle communications terminals 7. In detail, the control unit 3 classifies the multiple in-vehicle communications terminals 7 into groups based on an end number of the terminal ID to vary the individual start times every group.

Then, when the control unit 3 determines that the thus determined time of day for starting the software downloading is reached (YES at Step C7), it generates a download start permit signal including a file name of the software to cause the communications unit 4 to send out it to the in-vehicle communications terminal 7 via the wireless base station 8 at Step C8. It further starts the software downloading to the in-vehicle communications terminal 7 at Step C9.

Again, in the in-vehicle communications terminal 7, when the control unit 9 determines that the wireless communications unit 10 receives the download start permit signal sent by the center communications terminal 2 (YES at Step V14), it extracts the file name of the software at Step V15 and starts the software downloading at Step V16.

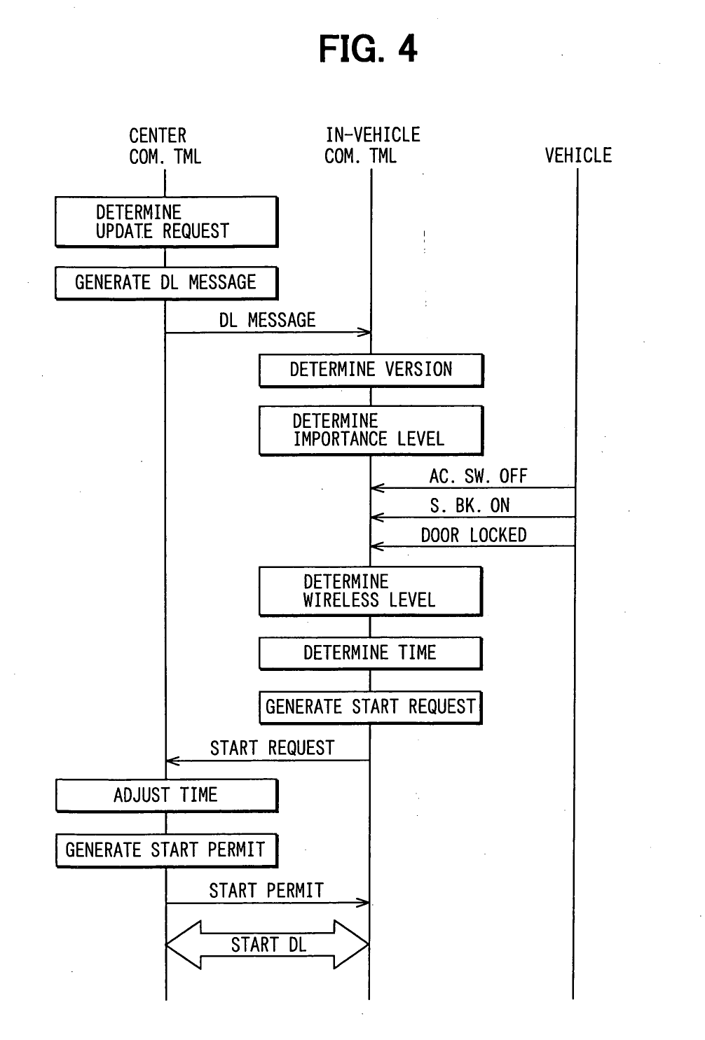

Through the above-mentioned process, when the update request for updating the software of the in-vehicle communications terminal 7 is generated and the importance level of the downloaded software is less than the predetermined level, the in-vehicle communications terminal 7 does not immediately start the software downloading as shown in FIG. 4. Namely, it starts the software downloading when the accessory switch 15 is being turned off; the parking brake 16 is being turned on; the door is opened, closed, and locked; and the wireless communications environment level is not less than the predetermined level.

By contrast, in the in-vehicle communications terminal 7, when the importance level of the downloaded software is not less than the predetermined level, the control unit 9 determines that the immediate downloading of the software is necessary (YES at Step V6). Then, the control unit 9 determines whether another communications process takes place at Step V17. When another is determined to take place (YES at Step V17), the another process that takes place is immediately stopped at Step V18. The control unit 9 further generates a download start request signal including the own terminal ID and the version of the currently possessed software to cause the wireless communications unit 10 to send it to the center communications terminal 2 at Step V9.

In the center communications terminal 2, when the control unit 3 detects that the communications unit 4 receives the download start request signal sent by the in-vehicle communications terminal 7 (YES at Step C3), it thereby detects that the time of day for starting the software downloading is not included in the request (NO at Step C4). The control unit 4 then extracts the terminal ID and version of the software at Step C10. The control unit 3 generates a download start permit signal including the file name of the software to cause the communications unit 4 to send it to the in-vehicle communications terminal 7 via the wireless base station 8 at Step C8. It then starts the software downloading to the in-vehicle communications terminal 7 at Step C9.

In the in-vehicle communications terminal 7, when the control unit 9 detects that the wireless communications unit 10 receives the download start permit signal (YES at Step V14), it extracts the file name of the software at Step V15 to start the software downloading at Step V16.

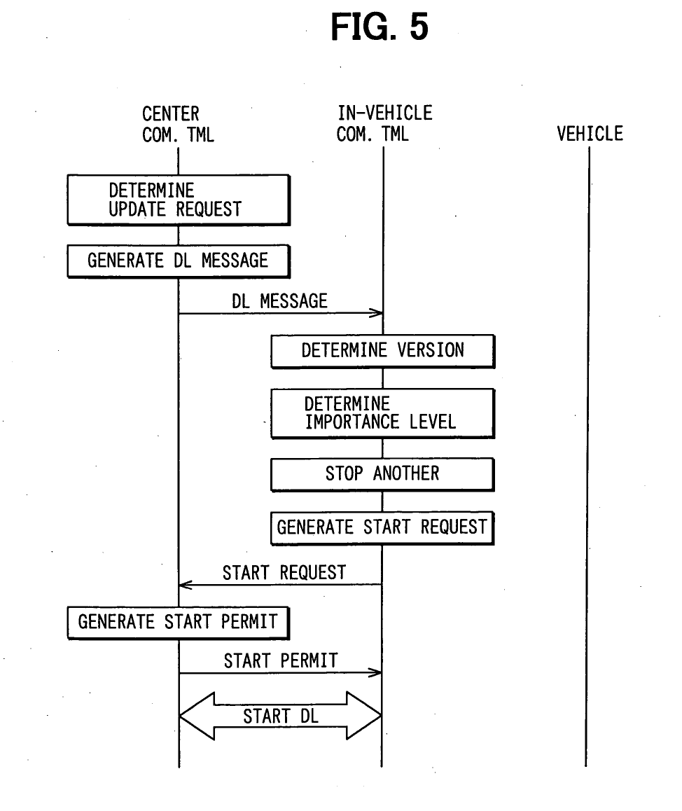

Through the above-mentioned process, when the update request for updating the software of the in-vehicle communications terminal 7 is generated and the importance level of the downloaded software is not less than the predetermined level, the in-vehicle communications terminal 7 immediately stops other communications processes that take place. Then it immediately starts the software downloading from the center communications terminal 2. This sequence is shown in FIG. 5.

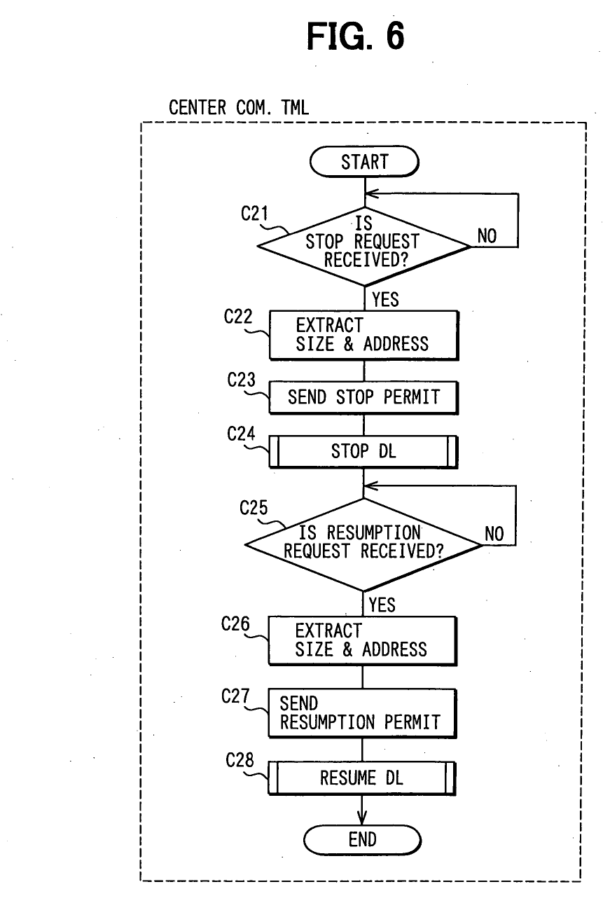

(2) Resuming Process (refer to FIGS. 6 to 11)

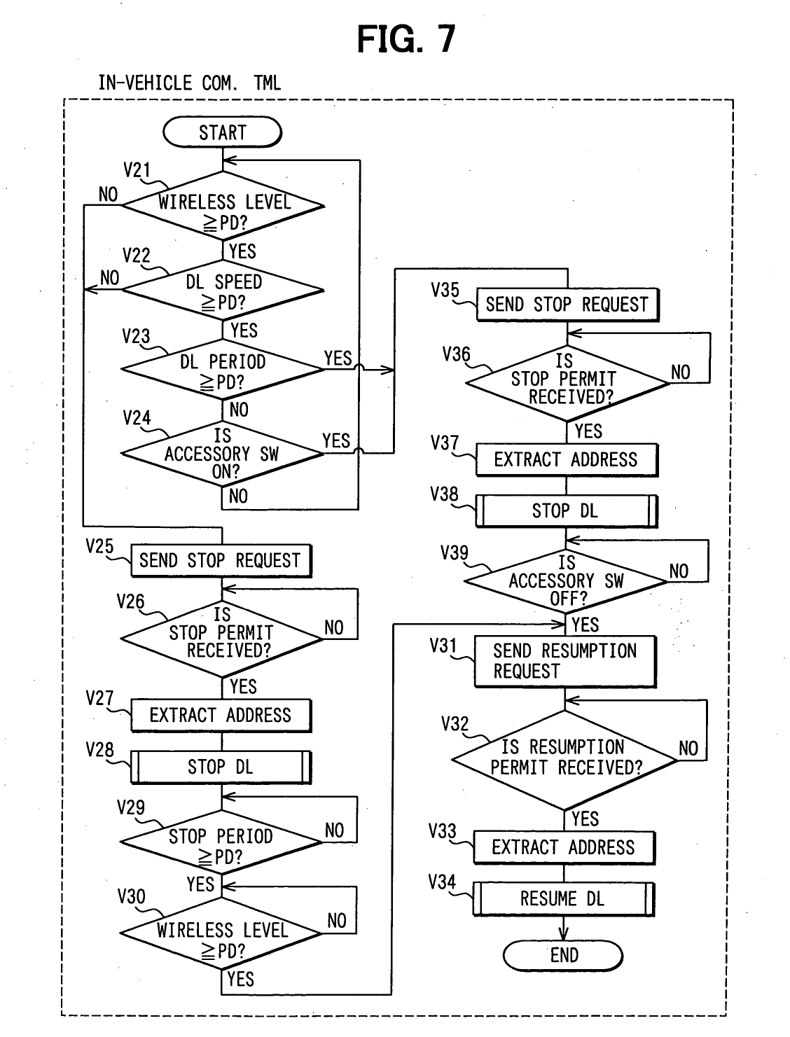

Referring to FIG. 7, after starting the software downloading, the control unit 9 determines as follows: whether the wireless communications environment level between the in-vehicle communications terminal 7 and center communications terminal 2 is equal to or more than a predetermined level at Step V22; whether a downloading speed from the center communications terminal 2 is equal to or more than a predetermined speed at Step V22; whether an elapsed time for downloading is equal to or more than a predetermined (PD) time at Step V23; and whether the accessory switch 15 is turned on at Step V24.

Here, when the control unit 9 detects that the wireless communications environment level is less than the predetermined (PD) level (NO at Step V21), or that the downloading speed is less than the predetermined (PD) speed (NO at Step V22), it generates a download stop request signal including a completion size and completion address. It further causes the wireless communications unit 10 to send the download stop request signal to the center communications terminal 2 at Step V25. Here, the completion size means the file size that is completely received up to this moment, while the completion address means the file address that is completely received up to this moment.

Referring to FIG. 6, in the center communications terminal 2, when the control unit 3 detects that the communications unit 4 receives the download stop request signal sent by the in-vehicle communications terminal 7 (YES at Step C21), it extracts the completion size and completion address from the download stop request signal at Step C22. It further computes a resumption address where the downloading is to be next resumed based on the extracted completion size and address. It yet further generates a download stop permit signal including the computed resumption address to cause the communications unit 4 to send it via the wireless base station 8 to the in-vehicle communications terminal 7 at Step C23. The software downloading to the in-vehicle communications terminal 7 is thereby stopped at Step C24.

In the in-vehicle communications terminal 7, when the control unit 9 detects that the wireless communications unit 10 receives the download stop permit signal sent by the center communications terminal 2 (YES at Step V26), it extracts the resumption address at Step V27 and stops the software downloading from the center communications terminal at Step V28.

The control unit 9 then determines whether a predetermined (PD) stop period elapses at Step V29. When the predetermined stop period is determined to elapse (YES at Step 29), the control unit 9 determines whether a wireless communications environment level between the in-vehicle communications terminal 7 and center communications terminal 2 is equal to or more than a predetermined level at Step V30. Here, the predetermined stop period can be uniformly set by the center communications terminal 2 (in common for the multiple in-vehicle communications terminal 7) or set individually for each of the in-vehicle communications terminals 7.

When the control unit 9 detects that the wireless communications environment level is equal to or more than the predetermined (PD) level (YES at Step V30), it generates a download resumption request signal including a completion size and a completion address to cause the wireless communications unit 10 to send it to the center communications terminal 2 at Step V31.

In the center communications terminal 2, when the control unit 3 detects that the communications unit 4 detects the download resumption request signal (YES at Step C25), it extracts the completion size and completion address at Step C26. The control unit 3 then generates a download resumption permit signal including the resumption address to cause the communications unit 4 to send it to the in-vehicle communications terminal 7 at Step C27. The software downloading to the in-vehicle communications terminal 7 is thereby resumed at Step C28.

In the in-vehicle communications terminal 7, when the control unit 9 detects that the wireless communications unit 10 receives the download resumption permit signal (YES at Step V32), it extracts the resumption address from the download resumption permit signal at Step V33. The software downloading is thereby resumed at Step V34.

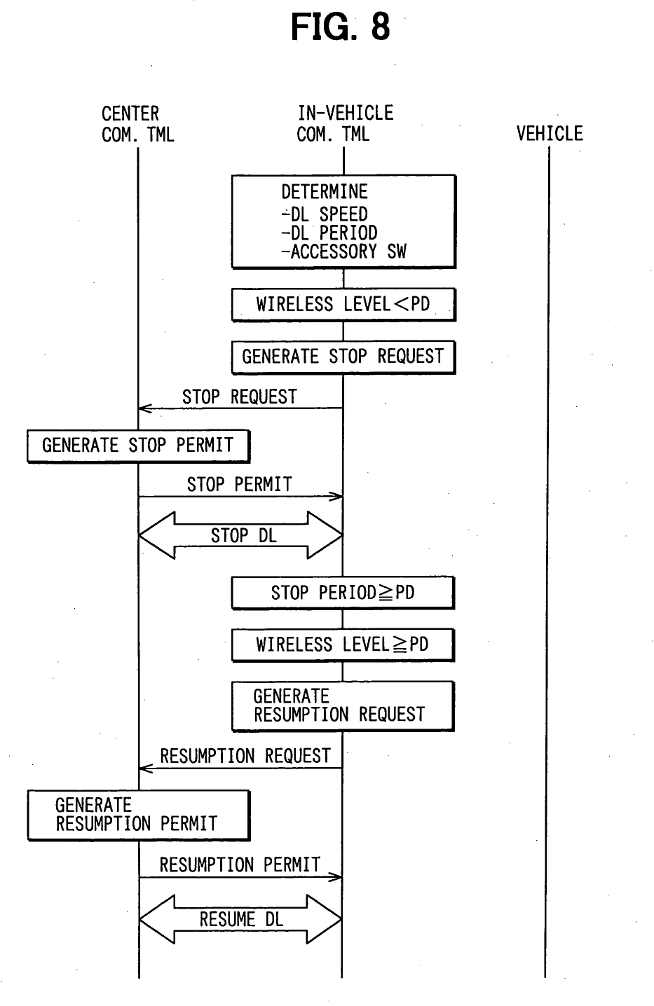

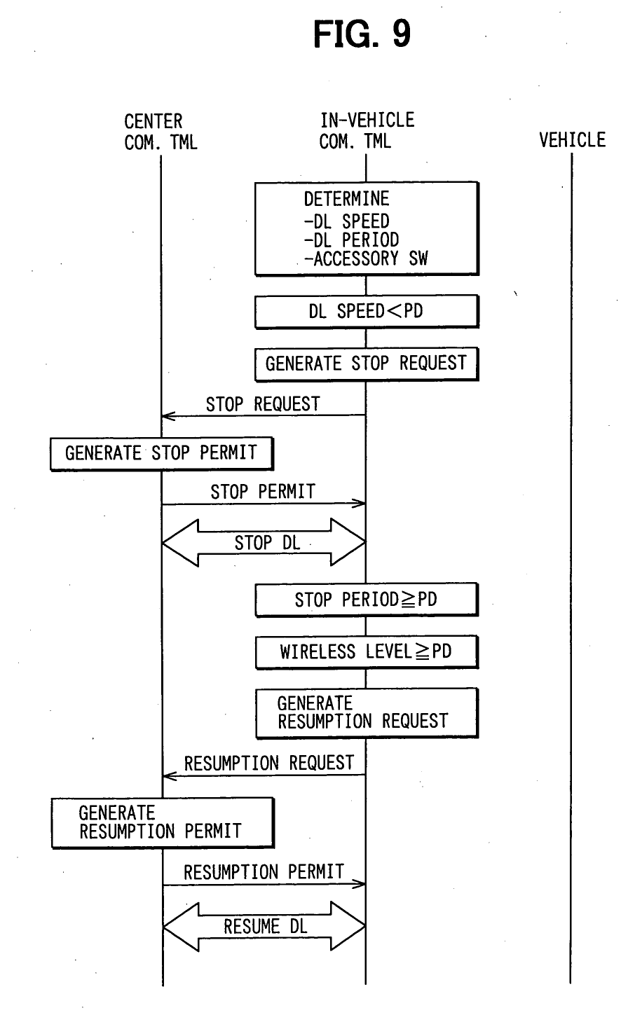

Through the above-mentioned processes, as shown in FIG. 8, after the downloading is started, the in-vehicle communications terminal 7 stops the downloading when the wireless communications environment level becomes less than a predetermined level. The in-vehicle communications terminal 7 thereafter resumes the downloading when a predetermined stop period elapses and the wireless communications environment level becomes equal to or more than the predetermined level. Furthermore, as shown in FIG. 9, after the downloading is started, the in-vehicle communications terminal 7 stops the downloading when a downloading speed becomes less than a predetermined speed. The in-vehicle communications terminal 7 thereafter resumes the downloading when a predetermined stop period elapses and the wireless communications environment level becomes equal to or more than the predetermined level.

By contrast, when the control unit 9 detects that a predetermined downloading period elapses (YES at Step V23) or when it detects that the accessory switch 15 is turned on (YES at Step V24), it also generates a download stop request signal including a completion size and completion address to cause the wireless communications unit 10 to send it to the center communications terminal 2 at Step V35.

When the control unit 9 then detects that the wireless communications unit 10 receives the download stop permit signal (YES at Step V36), it extracts the resumption address at Step V37 to stop the software downloading at Step V38.

Here, the control unit 9 does not determine whether a predetermined stop period elapses, but determines whether the accessory switch 15 is turned off at Step V39. When the accessory switch 15 is determined to be turned off (YES at Step V39), the control unit 9 generates a download resumption request signal including a completion size and completion address to cause the wireless communications unit 10 to send it to the center communications terminal 2 at Step V31.

When the control unit 9 detects that the wireless communications unit 10 receives the download resumption permit signal (YES at Step V32), it extracts the resumption address from the download resumption permit signal at Step V33. The software downloading is thereby resumed at Step V34.

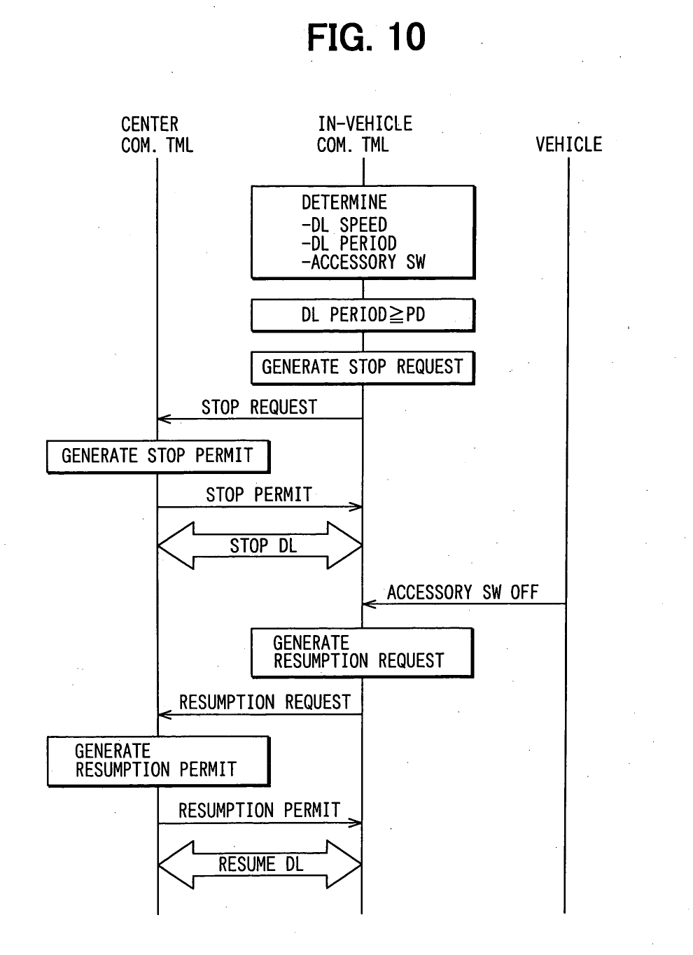

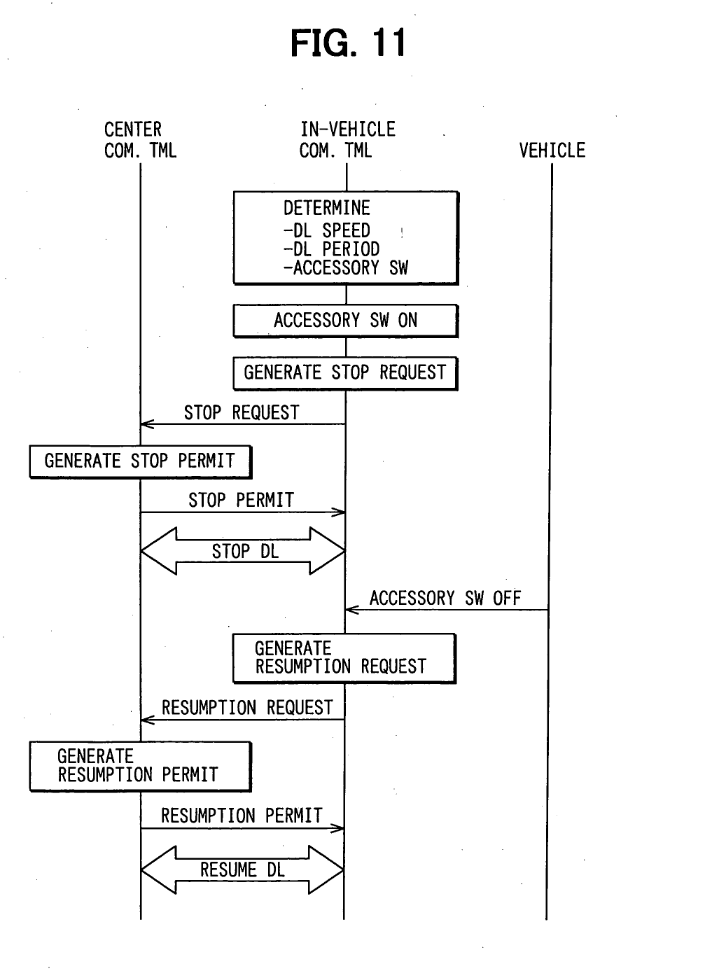

Through the above-mentioned processes, as shown in FIG. 10, after the downloading is started, the in-vehicle communications terminal 7 stops the downloading when the predetermined download period elapses. The in-vehicle communications terminal 7 thereafter resumes the downloading when the accessory switch 15 is turned off. Furthermore, as shown in FIG. 11, after the downloading is started, the in-vehicle communications terminal 7 stops the downloading when the accessory switch 15 is turned on. The in-vehicle communications terminal 7 thereafter resumes the downloading when the accessory switch 15 is turned off.

(Others)

In the above embodiment, when the importance level extracted from a download message signal in the in-vehicle communications terminal 7 is less than a predetermined level, the downloading is executed when all the following conditions are fulfilled. Here the conditions are as follows: the accessory switch 15 is being turned off; the parking brake 16 is being turned on; and the door is opened, closed, and locked. However, even only when the accessory switch 15 is being turned off, the downloading can be executed.

When the importance level extracted from a download message signal in the in-vehicle communications terminal 7 is not less than a predetermined level, the in-vehicle communications terminal 7 stops any other communications processes that take place to start the software downloading from the center communications terminal 2. However, before starting the software downloading, the in-vehicle communications terminal can be structured to output a message indicating that other communications processes are to be stopped.

Further, in the in-vehicle communications terminal 7, not only a time of day for starting the software downloading but also a downloading period for the software downloading can be simultaneously determined by the in-vehicle communications terminal 7. Further, not only the time of day for starting the software downloading but also the downloading period can be simultaneously adjusted by the center communications terminal 2. This can prevent a great deal of load concentration where the multiple download start request signals are received from the multiple in-vehicle communications terminals 7.

Further, a software version possessed by the in-vehicle communications terminal 7 can be managed by the center communications terminal 2 instead of the in-vehicle communications terminal 7. This enables the center communications terminal 2 to determine whether the software downloading is necessary when the software update request is generated.

As explained in the above embodiment, the software downloading is started under the conditions as follows: an importance level of a software to be downloaded from the center communications terminal 2 is less than a predetermined level; and at least an accessory switch 15 of the vehicle 6 is being turned off. The accessory switch 15 being turned off indicates that a user of the vehicle 6 is not in the vehicle 6, or at least the vehicle 6 is not driven even if the user is in the vehicle 6. Thus, occupying a wireless communications line for the software downloading involves no problem, which enables the resource to be sufficiently utilized for the software downloading from the center communications terminal 2 to enhance efficiency of the software downloading.

Further, when a wireless communications environment level between the in-vehicle communications terminal 7 and center communications terminal 2 is not less than a predetermined level, the software downloading is started from the center communications terminal 2. This enables the software downloading to be effectively performed in a properly executable condition where a high throughput can be achieved.

Further, a time of day for starting a software downloading or a downloading period can be determined based on a terminal ID uniquely assigned to an in-vehicle communications terminal 7 by the in-vehicle communications terminal. This can prevent a great deal of load concentration from being generated in a center communications terminal 2 when the multiple in-vehicle communications terminals perform the software downloading from the center communications terminal. This also enables the respective in-vehicle communications terminals 7 to perform effective software downloadings from the center communications terminal 2. This is because the center communications terminal 2 can adjust the time of day for starting the software downloading or the downloading period among the multiple in-vehicle communications terminals 7 based on the respective terminal IDs.

Further, when an importance level of a software to be downloaded from the center communications terminal 2 is not less than a predetermined level in the in-vehicle communications terminal 7, the software downloading is executed in preference to other communications processes. This enables the software downloading to be properly performed according to the importance level, enhancing an effectiveness of the software downloading.

Further, a software downloading is stopped in the in-vehicle communications terminal 7 when a wireless communications environment level becomes less than a predetermined level or when a downloading speed becomes less than a predetermined speed. This can prevent unnecessary long downloading period with the center communications terminal 2, for instance, due to retransmission process. Here, when the in-vehicle communications terminal 7 is powered by an in-vehicle battery mounted in the vehicle 6, unnecessary power consumption can be prevented from occurring; therefore, the battery can be prevented from running out.

Further, a software downloading is stopped in the in-vehicle communications terminal 7 when a wireless communications environment level becomes less than a predetermined level or a downloading speed becomes less than a predetermined speed; then, when the wireless communications environment level becomes not less than the predetermined level while stopping the downloading, the software downloading is resumed. Namely, when a proper environment condition for the software downloading recovers, the software downloading is immediately resumed, providing an effective downloading.

Further, a software downloading is stopped in the in-vehicle communications terminal 7 when a downloading period becomes not less than a predetermined period. This prevent unnecessary occupation of the wireless communications line owing to the prolonged downloading. Here, similarly with the above explanation, when the in-vehicle communications terminal 7 is powered by an in-vehicle battery mounted in the vehicle 6, unnecessary power consumption can be prevented from occurring; therefore, the battery can be prevented from running out.

Further, when an accessory switch 15 of the vehicle 6 is turned on while the software downloading from the center communications terminal, the software downloading is stopped. This enables the communications line to be immediately released for other communications processes once a user of the vehicle 6 gets in the vehicle 6.

Further, a software downloading is stopped in the in-vehicle communications terminal 7 when a downloading period becomes not less than a predetermined period or an accessory switch 15 is turned on; thereafter, the software downloading is resumed when the accessory switch 15 is turned off. Namely, when a user is not in the vehicle or the vehicle is not driven even though the user is in the vehicle 6, the software downloading is immediately resumed, which achieving the effective software downloading.

Furthermore, the present invention is directed to not only a case where a software for the in-vehicle communications terminal 7 in the vehicle 6 is downloaded from the center communications terminal 2, but also to a case where a software for another in-vehicle device mounted in the vehicle 6 is downloaded from the center communications terminal 2.

Yet furthermore, a software downloading is started when an importance level of a software to be downloaded is less than a predetermined level with conditions other than an accessory switch being turned off and a parking brake being turned on. For instance, a seat sensor signal indicating whether a user is seated can be used for the condition.

It will be obvious to those skilled in the art that various changes may be made in the above-described embodiments of the present invention. However, the scope of the present invention should be determined by the following claims.

What is claimed is:

1. A wireless communications system between a center and a vehicle for a software downloading via a wireless communications network, the wireless communications system comprising:
a center communications terminal provided in the center for downloading a software; and
an in-vehicle communications terminal provided in the vehicle for receiving the software downloaded from the center communications terminal,
wherein the in-vehicle communications terminal includes vehicle-stop assuming means for assuming whether the vehicle is not driven, and
wherein, when the vehicle-stop assuming means assumes that the vehicle is not driven, the in-vehicle communications terminal is permitted to start the software downloading from the center communications terminal.

2. The wireless communications system of claim 1,
wherein the vehicle-stop assuming means assumes that the vehicle is not driven when an accessory switch of the vehicle is being turned off.

3. The wireless communications system of claim 1,
wherein the vehicle-stop assuming means assumes that the vehicle is not driven when a parking brake of the vehicle is being turned on.

4. The wireless communications system of claim 1, wherein the vehicle-stop assuming means assumes that the vehicle is
not driven when a door of the vehicle is opened, closed, and locked.

5. The wireless communications system of claim 1,
wherein the in-vehicle communications terminal further includes wireless-environment start determining means for determining, prior to starting the software downloading, whether a wireless communications environment level between the in-vehicle communications terminal and the center communications terminal is equal to or more than a predetermined level, and
wherein, when the wireless-environment start determining means determines, prior to starting the software downloading, that the wireless communications environment level is equal to or more than the predetermined level, the in-vehicle communications terminal is permitted to start the software downloading from the center communications terminal.

6. The wireless communications system of claim 1,
wherein a time of day for starting the software downloading and a downloading period for the software downloading are determined based on terminal identification information uniquely assigned to the in-vehicle communications terminal.

7. The wireless communications system of claim 1,
wherein the in-vehicle communications terminal further includes importance level determining means for determining whether a software to be downloaded has an importance level equal to or higher than a predetermined level, and
wherein, when the importance level determining means determines that the software to be downloaded has the importance level equal to or higher than the predetermined level, the in-vehicle communications terminal is permitted to start the software downloading from the center communications terminal in preference to other communications processes even when the vehicle-stop assuming means does not assume that the vehicle is not driven, and
wherein, when the importance level determining means determines that the software to be downloaded has the importance level lower than the predetermined level, the in-vehicle communications terminal is permitted to start the software downloading from the center communications terminal when the vehicle-stop assuming means assumes that the vehicle is not driven.

8. The wireless communications system of claim 1,
wherein the center communications terminal notifies the in-vehicle communications terminal of start information by using notice information, and
wherein the start information relates to whether the in-vehicle communications terminal is permitted to start the software downloading from the center communications terminal.

9. The wireless communications system of claim 1,
wherein the center communications terminal notifies the in-vehicle communications terminal of start information by using an electronic mail, and
wherein the start information relates to whether the in-vehicle communications terminal is permitted to start the software downloading from the center communications terminal.

10. The wireless communications system of claim 1,
wherein, when a wireless communications environment level between the in-vehicle communications terminal and the center communications terminal becomes less than a predetermined level while the software downloading, the in-vehicle communications terminal stops the software downloading from the center communications terminal.

11. The wireless communications system of claim 1,
wherein, when a downloading speed while the software downloading becomes less than a predetermined speed, the in-vehicle communications terminal stops the software downloading from the center communications terminal.

12. The wireless communications system of claim 1,
wherein the in-vehicle communications terminal stops the software downloading from the center communications terminal when at least one of a first and second stop conditions is fulfilled, wherein the first condition is that a wireless communications environment level between the in-vehicle communications terminal and the center communications terminal becomes less than a predetermined level, wherein a second condition is that a downloading speed while the software downloading becomes less than a predetermined speed, and
wherein, after the in-vehicle communications terminal stops the software downloading since at least one of the two conditions is fulfilled, the in-vehicle communications terminal is permitted to resume the software downloading from the center communications terminal when the wireless communications environment level becomes equal to or more than the predetermined level.

13. The wireless communications system of claim 1,
wherein, when an elapsed downloading period becomes equal to or more than a predetermined period, the in-vehicle communications terminal stops the software downloading from the center communications terminal.

14. The wireless communications system of claims 1,
wherein, when an accessory switch of the vehicle is turned on while the software downloading, the in-vehicle communications terminal stops the software downloading from the center communications terminal.

15. The wireless communications system of claim 1,
wherein the in-vehicle communications terminal stops the software downloading from the center communications terminal when at least one of a first and second stop conditions is fulfilled, wherein the first condition is that an elapsed downloading period becomes equal to or more than a predetermined period, wherein the second condition is that an accessory switch is turned on while the software downloading,
wherein, after the in-vehicle communications terminal stops the software downloading since at least one of the two conditions is fulfilled, the in-vehicle communications terminal is permitted to resume the software downloading from the center communications terminal when the accessory switch is turned off.

16. An in-vehicle communications terminal that is provided in a vehicle and used for a software downloading via a wireless communications network from a center communications terminal provided in a center, the in-vehicle communications terminal comprising:
wireless means for communicating with the center communications terminal via the wireless communications network;
control means for causing the wireless means to execute the software downloading; and
vehicle-stop assuming means for assuming whether the vehicle is not driven,
wherein, when the vehicle-stop assuming means assumes that the vehicle is not driven, the control means is permitted to cause the wireless means to start the software downloading from the center communications terminal.

17. The in-vehicle communications terminal of claim 16,
wherein the vehicle-stop assuming means assumes that the vehicle is not driven when an accessory switch of the vehicle is being turned off.

18. The in-vehicle communications terminal of claim 16,
wherein the in-vehicle communications terminal determines a time of day for starting the software downloading and a downloading period for the software downloading, based on terminal identification information uniquely assigned to the in-vehicle communications terminal, and
wherein the in-vehicle communications terminal executes the software downloading from the center communications terminal based on the determined time of day for starting the software downloading and the determined downloading period for the software downloading.

19. The in-vehicle communications terminal of claim 16, further comprising:
importance level determining means for determining whether a software to be downloaded has an importance level equal to or higher than a predetermined level, and
wherein, when the importance level determining means determines that the software to be downloaded has the importance level equal to or higher than the predetermined level, the control means is permitted to cause the wireless means to start the software downloading from the center communications terminal in preference to other communications processes even when the vehicle-stop assuming means does not assume that the vehicle is not driven, and
wherein, when the importance level determining means determines that the software to be downloaded has the importance level lower than the predetermined level, the control means is permitted to cause the wireless means to start the software downloading from the center communications terminal when the vehicle-stop assuming means assumes that the vehicle is not driven.

20. A center communications terminal provided in a center for executing a software downloading via a wireless communications network to an in-vehicle communications terminal provided in a vehicle, the center communications terminal comprising:
wireless means for communicating with the in-vehicle communications terminal via the wireless communications network; and
control means for causing the wireless means to execute the software downloading,
wherein the control means determines a time of day for starting the software downloading and a downloading period for the software downloading based on identification information uniquely assigned to the in-vehicle communications terminal, and
wherein the control means causes the wireless means to execute the software downloading based on the determined time of day for the software downloading and the downloading period for the software downloading.
